(19) United States
(12) Patent Application Publication
(10) Pub. No.: US 2006/0063687 A1
(43) Pub. Date: Mar. 23, 2006

(54) Composition and process for ashless removal of post-etch photoresist and/or bottom anti-reflective material on a substrate

(76) Inventors: David W. Minsek, New Milford, CT (US); David D. Bernhard, Newtown, CT (US); Thomas H. Baum, New Fairfield, CT (US)

Correspondence Address: ATMI, INC., 7 COMMERCE DRIVE, DANBURY, CT, 06810, US

(21) Appl. No.: 10/944,491

(22) Filed: Sep. 17, 2004

(51) Int. Cl. C11D 7/32

(52) U.S. Cl. 510/175

(57) ABSTRACT

An aqueous-based composition and process for removing photoresist and/or bottom anti-reflective coating (BARC) material from a substrate having such material(s) thereon. The aqueous-based composition includes a quaternary ammonium base, at least one co-solvent, and optionally a chelator. The composition achieves high-efficiency removal of photoresist and/or BARC material in the manufacture of integrated circuitry without adverse effect on metal species on the substrate, such as copper, and without damage to SiOC-based dielectric materials employed in the semiconductor architecture.

### FIELD OF THE INVENTION

The present invention relates to an aqueous-based composition and process for the removal of post-etch photoresist and/or bottom anti-reflective coating material from a substrate or article having such material deposited thereon using the aqueous-based composition.

### DESCRIPTION OF THE RELATED ART

Photolithography techniques comprise the steps of coating, exposure, and development. A wafer is coated with a positive or negative photoresist substance and subsequently covered with a mask that defines patterns to be retained or removed in subsequent processes. Following the proper positioning of the mask, the mask has directed therethrough a beam of monochromatic radiation, such as ultraviolet (UV) light or deep UV (DUV) light (≈250 nm), to make the exposed photoresist material more or less soluble in a selected rinsing solution. The soluble photoresist material is then removed, or “developed,” thereby leaving behind a pattern identical to the mask.

In order to address transmissivity and reflectivity problems associated with the use of DUV light, which triggers an uneven exposure of the photoresist causing variations in linewidths, spacing and other critical dimensions, bottom anti-reflective coatings (BARCs) have been developed which are applied to substrates prior to applying the photoresist. As the photoresist is exposed to DUV radiation, the BARC absorbs a substantial amount of the DUV radiation thereby preventing radiation reflection and transmissivity, and hence uneven exposure. The BARC has an additional benefit of having a planarizing effect on topological wafer surfaces encountered in typical dual-damascene integration.

During back-end-of-line (BEOL) dual-damascene processing of integrated circuits, gas-phase plasma etching is used to transfer the patterns of the developed photoresist coating to an underlying dielectric coating. During pattern transfer, the reactive plasma gases react with the developed photoresist, resulting in the formation of a hardened, crosslinked polymeric material, or “crust,” on the surface of the photoresist. In addition, the reactive plasma gases react with the sidewalls of the BARC and the features etched into the dielectric.

After the pattern transfer, the hardened photoresist layer must be cleanly removed. Importantly, when a cleaner/etchant composition is used in BEOL applications to process surfaces having aluminum or copper interconnected wires, it is important that the composition used to remove photoresist residue and/or BARC possess good metal compatibility, e.g., a low etch rate on copper, aluminum, cobalt, etc.

Typically, the photoresist and crust is removed by plasma ashing or wet cleaning. However, plasma ashing, whereby the substrate is exposed to an oxidative or reductive plasma etch, may result in damage to the dielectric material, either by changing the feature shapes and dimensions, or by an increase in the dielectric constant of the dielectric material. The latter problem is more pronounced when low-k dielectric materials, such as organosilicate glasses (OSG), are the underlying dielectric material.

As such, it is often desirable to avoid the use of plasma ashing to remove the post-etch photoresist. However, liquid cleaners well known in the art have disadvantages as well, including the relative insolubility of the crust in the liquid cleaner and the risk of damage to the dielectric material caused by the liquid cleaner.

Liquid cleaners well known in the art include solutions comprising a 2-pyrolidinone compound, a diethylene glycol monoalkyl ether, a polyglycol and a quaternary ammonium hydroxide (see U.S. Pat. No. 4,744,834). However, this solution is devoid of water and as such, has a high content of hazardous substances which must be properly disposed of in an environmentally safe manner.

Hydroxylamine solutions have also been utilized in the art for photoresist removal, but such solutions have associated corrosion, toxicity and reactivity problems that limit their use, with adverse corrosion effects being particularly problematic when copper is employed in the integrated circuitry.

Unfortunately, although aqueous solutions are highly desirable because of the simpler disposal techniques, aqueous solutions may not be effective for the removal of hardened photoresist. For example, often substantial quantities of co-solvents, wetting agents and/or surfactants are added to the aqueous solutions to improve the cleaning ability of the solution.

The art therefore has a continuing need for improved aqueous-based removal compositions containing quaternary ammonium hydroxide, co-solvents and other additives to improve the removal of post-etch hardened photoresist and/or BARC layers from the surface of a substrate having such material(s) thereon.

### SUMMARY OF THE INVENTION

The present invention generally relates to an aqueous-based removal composition and process for the removal of post-etch photoresist and/or BARC material from a substrate or article having such material deposited thereon using the aqueous-based removal composition. The aqueous-based removal composition includes a quaternary ammonium base, at least one co-solvent and optionally, a chelator.

One aspect of the invention relates to an aqueous-based removal composition useful for removing photoresist and/or bottom anti-reflective coating (BARC) materials from a substrate having such material(s) thereon, said composition including a quaternary ammonium hydroxide, at least one co-solvent and optionally, a chelator.

In another aspect, the invention relates to a method of removing photoresist and/or BARC material from a substrate having said material thereon, said method comprising contacting the substrate with an aqueous-based removal composition for sufficient time to at least partially remove said material from the substrate, wherein the aqueous-based removal composition includes a quaternary ammonium hydroxide, at least one co-solvent and optionally, a chelator.

In yet another aspect, the present invention relates to an aqueous-based removal composition useful for removing chemical mechanical polishing residue from a substrate having such material(s) thereon, said composition comprising a quaternary ammonium hydroxide, at least one co-solvent and a chelator.

In a further aspect, the present invention relates to a method of removing chemical mechanical polishing residue from a substrate having said material thereon, said method comprising contacting the substrate with an aqueous-based removal composition for sufficient time to at least partially remove said material from the substrate, wherein the aqueous-based removal composition includes a quaternary ammonium hydroxide, at least one co-solvent and a chelator.

Other aspects, features and advantages of the invention will be more fully apparent from the ensuing disclosure and appended claims.

### DETAILED DESCRIPTION OF THE INVENTION, AND PREFERRED EMBODIMENTS THEREOF

The present invention contemplates aqueous-based removal compositions that are useful to remove photoresist and/or bottom anti-reflective coating (BARC) materials from a substrate having such material(s) thereon. “Photoresist,” as used herein, refers to untreated, i.e., developed only, or treated, i.e., developed and subsequently hardened by a process including ion implantation and gas-phase plasma etching.

The aqueous-based removal composition of the present invention includes (a) a quaternary ammonium hydroxide, (b) co-solvent A, (c) optionally co-solvent B and (d) optionally a chelator, with water making up the remainder of the solution.

Compositions of the invention may be embodied in a wide variety of specific formulations, as hereinafter more fully described.

In all such compositions, wherein specific components of the composition are discussed in reference to weight percentage ranges including a zero lower limit, it will be understood that such components may be present or absent in various specific embodiments of the composition, and that in instances where such components are present, they may be present at concentrations as low as 0.01 weight percent, based on the total weight of the composition in which such components are employed.

The present invention in one aspect thereof relates to an aqueous-based composition useful for removal of BARCs and/or photoresist that is compatible with copper and other interconnect metals. The aqueous-based composition effectively removes essentially all photoresist from the top of the semiconductor device without causing damage to the dielectric material and without causing corrosion of the underlying metal. The composition comprises water, quaternary ammonium hydroxide, at least one co-solvent and optionally, a chelator, present in the following ranges, based on the total weight of the composition.

| component | % by weight |
|---|---|
| water | about 50.0% to about 90.0% |
| quaternary ammonium hydroxide | about 1.0% to about 10.0% |
| co-solvent A | about 1.0% to about 25.0% |
| co-solvent B | 0.0% to about 20.0% |
| chelator | 0.0% to about 1.0% |

In the broad practice of the invention, the aqueous-based removal composition may comprise, consist or, or consist essentially of water, quaternary ammonium hydroxide, at least one co-solvent and optionally, a chelator.

Such composition may optionally include additional components, including stabilizers, dispersants, anti-oxidants, penetration agents, adjuvants, additives, fillers, excipients, etc., that are preferably inactive in the composition.

In the broad practice of the invention, the pH range of the aqueous-based removal composition is from about 7 to about 14, preferably from about 8 to about 10.

The quaternary ammonium hydroxide, which provides the high-pH environment necessary for the dissolution of photoresist and “lift-off” of the crust, can be represented by the formula R¹R²R³R⁴N⁺OH⁻, where R¹, R², R³ and R⁴ may be the same as or different from one another and each is independently selected from the group consisting of C₁-C₆ alkyl groups or aryl groups. In a preferred embodiment, the quaternary ammonium hydroxide is tetramethylammonium hydroxide (TMAH).

The inclusion of co-solvents with the quaternary ammonium hydroxide serves to increase the solubility of the composition for hardened photoresist, relative to an aqueous solution of quaternary ammonium hydroxide alone. Additionally, the co-solvent may serve to both (i) increase particle removal, i.e. insoluble photoresist residues, by lifting-off the residue into the solution and (ii) decreasing the formation of water marks which remain after rinsing. These are accomplished by a lowering of the surface tension of the solution by addition of co-solvent which has a dual hydrophobic-hydrophilic character similar to a surfactant. Co-solvent A can be a polyglycol ether represented by the formula HO(CH₂CHR¹O)ₙR², wherein R¹ is hydrogen or a methyl group, R² is a straight-chained, branched or cyclic C₂-C₆ alkyl group or an aryl group, and n≧1. Examples include, but are not limited to, diethylene glycol monomethyl ether, triethylene glycol monomethyl ether, diethylene glycol monoethyl ether, triethylene glycol monoethyl ether, ethylene glycol monopropyl ether, ethylene glycol monobutyl ether, diethylene glycol monobutyl ether, triethylene glycol monobutyl ether, ethylene glycol monohexyl ether, diethylene glycol monohexyl ether and ethylene glycol phenyl ether. In a preferred embodiment, co-solvent A is a diethylene glycol, specifically diethylene glycol monomethyl ether (DEGME).

Alternatively, co-solvent A can be a polyglycol ether represented by the formula HO(CHR¹CH₂O)ₙR², wherein R¹, R² and n are as introduced above. Examples include, but are not limited to, propylene glycol methyl ether, dipropylene glycol methyl ether, tripropylene glycol methyl ether, propylene glycol n-propyl ether, dipropylene glycol n-propyl ether, tripropylene glycol n-propyl ether, propylene glycol n-butyl ether, dipropylene glycol n-butyl ether, tripropylene glycol n-butyl ether, and propylene glycol phenyl ether.

Co-solvent B can be a water soluble glycol or a polyglycol ether, wherein the polyglycol ether has the formula HO(CH₂CHR¹O)ₙR² or HO(CHR¹CH₂O)ₙR², and R¹, R² and n are as introduced above. The water soluble glycol can have the general formula C₂ₙH₄ₙ₊₂Oₙ₊₁, wherein n≧1. Examples of water soluble glycols include ethylene glycol, propylene glycol and neopentyl glycol. Alternatively, the water soluble glycol has the general formula H(OCH₂CH₂)ₙOH, wherein n≧1. Examples include polyethylene glycols. Preferably, co-solvent B is a polyglycol ether having a butyl R² group, such as diethylene glycol monobutyl ether.

As used herein, in reference to the present invention, the term “aryl” is intended to be broadly construed as referring to carbocyclic (e.g., phenyl, naphthyl) as well as heterocyclic aromatic groups (e.g., pyridyl, thienyl, furanyl, etc.) and encompassing unsubstituted as well as substituted aryl groups, wherein the substituents of substituted aryl groups may include any sterically acceptable substituents which are compatible with such aryl groups and which do not preclude the efficacy of the co-solvent compound for its intended utility. Examples of substituents for substituted aryl groups include one or more of halogen (e.g., fluoro, chloro, bromo, and iodo), amino, amido, C₁-C₄ alkyl, C₁-C₄ alkoxy, nitro, trifluoromethyl, hydroxy, hydroxyalkyl containing a C₁-C₄ alkyl moiety, etc.

The co-solvent(s) improve the removal ability of the aqueous-based composition by lowering the surface tension (γ) of the composition. Stated otherwise, the co-solvent acts as a surfactant type additive due to its dual hydrophobic/hydrophilic nature, thus avoiding the use of a conventional surfactant which may cause foaming problems and/or absorb onto the container surfaces.

In one aspect of this invention, the co-solvent(s) are chosen in order to make the polar component of the surface tension (γₚ) approach 0 (zero) dyne/cm² in order to improve photoresist removal. Preferably, γₚ is from about 10 dyne/cm² to about 0 dyne/cm².

The surface tension of the aqueous-based solution, designated simply γ, may be determined using the pendant drop shape analysis method. Preferably, γ is from about 25 dyne/cm² to about 45 dyne/cm². Total surface tension of the aqueous-based solution (γ) is assumed to consist of the sum of the dispersive and polar components, γ_{d} and γₚ, respectively, according to equation (1) below.
γ=γ_{d}+γₚ (1)

The dispersive component (γ_{d}) may be estimated from the measured contact angle (θ) of the solution on polytetrafluoroethylene (PTFE) film (θ_{PTFE}), according to equation (2) below. Thereafter, the polar component, γₚ, may be obtained by simple algebraic manipulation of equation (1).

$${γ}_{d} = \frac{{{γ}^{2} ( cos {θ}_{PTFE} + 1 )}^{2}}{72} \qquad ( 2 )$$

The chelator serves to passivate metals by selective binding to metal surfaces, especially metallic copper. The chelator may also improve the ability of the solution to selectively remove copper oxides from copper surfaces which may be present on the substrate. The chelator in such composition can be of any suitable type, and may include, without limitation, triazoles, such as 1,2,4-triazole, or triazoles substituted with substituents such as C₁-C₈ alkyl, amino, thiol, mercapto, imino, carboxy and nitro groups, such as benzotriazole, tolyltriazole, 5-phenyl-benzotriazole, 5-nitro-benzotriazole, 3-amino-5-mercapto-1,2,4-triazole, 1-amino-1,2,4-triazole, hydroxybenzotriazole, 2-(5-amino-pentyl)-benzotriazole, 1-amino-1,2,3-triazole, 1-amino-5-methyl-1,2,3-triazole, 3-amino-1,2,4-triazole, 3-mercapto-1,2,4-triazole, 3-isopropyl-1,2,4-triazole, 5-phenylthiol-benzotriazole, halo-benzotriazoles (halo=F, Cl, Br or I), naphthotriazole, and the like, as well as thiazoles, tetrazoles, imidazoles, phosphates, thiols and azines such as 2-mercaptobenzoimidizole, 2-mercaptobenzothiazole, 4-methyl-2-phenylimidazole, 2-mercaptothiazoline, 5-aminotetrazole, 5-amino-1,3,4-thiadiazole-2-thiol, 2,4-diamino-6-methyl-1,3,5-triazine, thiazole, triazine, methyltetrazole, 1,3-dimethyl-2-imidazolidinone, 1,5-pentamethylenetetrazole, 1-phenyl-5-mercaptotetrazole, diaminomethyltriazine, mercaptobenzothiazole, imidazoline thione, mercaptobenzimidazole, 4-methyl-4H-1,2,4-triazole-3-thiol, 5-amino-1,3,4-thiadiazole-2-thiol, benzothiazole, tritolyl phosphate, indiazole, salicylic acid, gallic acid, iminodiacetic acid, etc. An especially preferred chelator for this purpose is 2-mercaptobenzimidazole (2-MBI).

Specific embodiments of such compositions are set out as Formulations A-E in Table 1 below, in percentages by weight, based on the total weight of the composition. For ease of reference, TMAH is tetramethylammonium hydroxide (the quaternary ammonium hydroxide), DEGME is diethyleneglycol monomethyl ether (co-solvent A), and DEGBE is diethylene glycol monobutyl ether (co-solvent B).

TABLE 1

| | % wt. | % wt. | % wt. | % wt. |
|---|---|---|---|---|
| Example | TMAH | DEGME | DEGBE | water |
| A | 5.0 | 0 | 0 | 95.0 |
| B | 5.0 | 25.0 | 0 | 70.0 |
| C | 5.0 | 25.0 | 4.0 | 66.0 |
| D | 5.0 | 20.0 | 8.0 | 67.0 |
| E | 5.0 | 20.0 | 10.0 | 65.0 |

The aqueous-based compositions of the invention are easily formulated by simple addition of the respective ingredients and mixing to homogeneous condition.

In photoresist and/or BARC removal application, the aqueous-based composition is applied in any suitable manner to the material to be cleaned, e.g., by spraying the aqueous-based composition on the surface of the material to be cleaned, by dipping (in a volume of the aqueous-based composition) of the material or article including the material to be cleaned, by contacting the material or article to be cleaned with another material, e.g., a pad, or fibrous sorbent applicator element, that is saturated with the aqueous-based composition, or by any other suitable means, manner or technique by which the aqueous-based composition is brought into removal contact with material to be cleaned.

As applied to semiconductor manufacturing operations, the aqueous-based compositions of the present invention are usefully employed to remove photoresist and/or BARC materials from substrates and semiconductor device structures on which such material(s) have been deposited.

The compositions of the present invention, by virtue of their selectivity for such photoresist and/or BARC materials relative to other materials that may be present on the semiconductor substrate, e.g., ILD structures, metallization, barrier layers, etc., achieve removal of the photoresist and/or BARC material(s) in a highly efficient manner.

In use of the compositions of the invention for removing photoresist and/or BARC materials from semiconductor substrates having same thereon, the aqueous-based composition typically is contacted with the substrate for a time of from about 1 minute to about 10 minutes, at temperature in a range of from about 50° C. to about 80° C. Such contacting times and temperatures are illustrative, and any other suitable time and temperature conditions may be employed that are efficacious to at least partially remove the photoresist and/or BARC material from the substrate, within the broad practice of the invention.

Following the achievement of the desired removal action, the aqueous-based composition is readily removed from the substrate or article to which it has previously been applied, e.g., by rinse, wash, or other removal step(s), as may be desired and efficacious in a given end use application of the compositions of the present invention.

In yet another embodiment, the aqueous-based compositions of the invention may be diluted and used as a post chemical mechanical polishing (CMP) clean. Contaminants/residue that originate from the CMP slurry or abrasive particles in the polishing pad may settle on the wafer surface subsequent to polishing. To remove the contaminants, a post-CMP wet cleaning step is often used. It has been surprisingly discovered that when the aqueous-based compositions of the present invention are diluted with deionized water in a ratio (deionized water to aqueous-based compositions) of about 20:1 to about 60:1, the diluted aqueous-based composition efficaciously removes CMP contaminants from the surface of the wafer. In a preferred embodiment, the aqueous-based compositions F-J, as disclosed in Table 2, are diluted in a ratio of about 20:1 to about 60:1 and used to clean contaminants from post-CMP wafers.

TABLE 2

| | % wt. | % wt. | % wt. | % wt. 2- | |
|---|---|---|---|---|---|
| Example | TMAH | DEGME | DEGBE | MBI | % wt. water |
| F | 5.0 | 25.0 | 4.0 | 0.1 | 65.9 |
| G | 5.0 | 20.0 | 8.0 | 0.1 | 66.9 |
| H | 5.0 | 20.0 | 10.0 | 0.1 | 64.9 |

It is noted that the dilute aqueous-based compositions of this invention are suitable for removing contaminants from a silicon wafer both during and after CMP. The dilute aqueous-based compositions can be used to clean the post-CMP wafer using conventional wafer cleaning techniques including, but not limited to, brushing, jet-cleaning and ultrasonic-cleaning techniques.

The features and advantages of the invention are more fully illustrated by the following non-limiting examples, wherein all parts and percentages are by weight, unless otherwise expressly stated.

### EXAMPLE 1

Samples of Formulations A, B, C, D, and E, having the respective compositions described hereinabove in Table 1, were prepared.

The surface tension of formulations A-E were measured as described herein, and are given in Table 2 below.

TABLE 3

| | measured γ | | estimated γ_{d} | estimated γₚ |
|---|---|---|---|---|
| Example | (dyne/cm²) | measured θ_{PTFE} | (dyne/cm²) | (dyne/cm²) |
| A | 80.5 | 110.1° | 30.0 | 46.5 |
| B | 56.8 | 103.9° | 25.9 | 30.9 |
| C | 43.2 | 79.0° | 36.8 | 6.4 |
| D | 39.0 | 64.1° | 43.6 | ˜0 |
| E | 37.2 | 58.4° | 44.6 | ˜0 |

The efficacy of these formulations for removing photoresist and/or BARC from a substrate containing same deposited thereon, while maintaining a low etching action with respect to copper metallization on such substrate, was evaluated in corresponding tests in which the aqueous-based composition of the particular formulation was contacted with the substrate for about 3 minutes to about 4 minutes at about 60° C. followed by rinsing of the substrate with deionized water and blow-drying with nitrogen gas. The substrate was a dual-damascene type structure of post-plasma etched, non-ashed photoresist and organic BARC over a trench/via pattern in organosilicate dielectric material, such as is typical for BEOL chip manufacture. Substantial removal is defined as greater than 80% removal of the photoresist from the semiconductor device, as determined by optical microscopy. The photoresist/BARC removal efficiency as estimated visually is given in Table 3.

TABLE 4

| | percent removal at 3 min | % removal at 4 min |
|---|---|---|
| Example | immersion | immersion |
| A | 0% | 50% |
| B | 50% | 65% |
| C | 90% | 95% |
| D | 95% | >99% |
| E | 95% | >99% |

It can be seen that the addition of diethylene glycol monobutyl ether (co-solvent B) to formulations C-E, wherein DEGBE has a bulky and non-polar butyl end group, resulted in a reduction of the surface tension of the polar component to less than about 10 dyne/cm² with a concomitant increase in removal efficiency.

Accordingly, the aqueous-based compositions of the present invention achieve a substantial advance in the art of removing photoresist and/or BARC materials, in the manufacture of integrated circuit devices.

Although the invention has been variously disclosed herein with reference to illustrative embodiments and features, it will be appreciated that the embodiments and features described hereinabove are not intended to limit the invention, and that other variations, modifications and other embodiments will suggest themselves to those of ordinary skill in the art, based on the disclosure herein. The invention therefore is to be broadly construed, as encompassing all such variations, modifications and alternative embodiments within the spirit and scope of the claims hereafter set forth.

What is claimed is:

1. An aqueous-based removal composition useful for removing photoresist and/or bottom anti-reflective coating (BARC) materials from a substrate having such material(s) thereon, said composition comprising a quaternary ammonium hydroxide, at least one co-solvent and optionally, a chelator.

2. The composition of claim 1, comprising the following components based on the total weight of the composition:
50.0% wt.-90.0% wt. water
1.0% wt.-10.0% wt. quaternary ammonium hydroxide;
1.0% wt.-25.0% wt. co-solvent A;
optionally 0.0% wt.-20.0% wt. co-solvent B; and
optionally 0.0% wt.-1.0% wt. chelator,
wherein the total of the weight percentages of such components of the composition does not exceed 100% weight.

3. The composition of claim 2, wherein the quaternary ammonium hydroxide comprises a compound represented by the formula R¹R²R³R⁴N⁺OH⁻, where R¹, R², R³ and R⁴ are the same as or different from one another and are C₁-C₆ alkyl groups or aryl groups.

4. The composition of claim 2, wherein the quaternary ammonium hydroxide comprises tetramethylammonium hydroxide (TMAH).

5. The composition of claim 2, wherein co-solvent A comprises a compound represented by the formula HO(CH₂CHR¹O)ₙR², wherein R¹ is hydrogen or a methyl group, R² is a straight-chained, branched or cyclic C₂-C₆ alkyl group or an aryl group, and n≧1.

6. The composition of claim 2, wherein co-solvent A comprises a polyglycol ether selected from the group consisting of diethylene glycol monomethyl ether, triethylene glycol monomethyl ether, diethylene glycol monoethyl ether, triethylene glycol monoethyl ether, ethylene glycol monopropyl ether, ethylene glycol monobutyl ether, diethylene glycol monobutyl ether, triethylene glycol monobutyl ether, ethylene glycol monohexyl ether, diethylene glycol monohexyl ether, and ethylene glycol phenyl ether.

7. The composition of claim 2, wherein co-solvent A comprises diethylene glycol monomethyl ether.

8. The composition of claim 2, wherein co-solvent A comprises a compound represented by the formula HO(CHR¹CH₂O)ₙR², wherein R¹ is hydrogen or a methyl group, R² is a straight-chained, branched or cyclic C₂-C₆ alkyl group or an aryl group, and n≧1.

9. The composition of claim 2, wherein co-solvent A comprises a polyglycol ether selected from the group consisting of propylene glycol methyl ether, dipropylene glycol methyl ether, tripropylene glycol methyl ether, propylene glycol n-propyl ether, dipropylene glycol n-propyl ether, tripropylene glycol n-propyl ether, propylene glycol n-butyl ether, dipropylene glycol n-butyl ether, tripropylene glycol n-butyl ether, and propylene glycol phenyl ether.

10. The composition of claim 2, said composition having a pH in a range of from about 8 to about 10.

11. The composition of claim 2, comprising co-solvent B.

12. The composition of claim 11, wherein co-solvent B comprises a compound represented by the formula selected from the group consisting of (a) HO(CH₂CHR¹O)ₙR², wherein R¹ is hydrogen or a methyl group, R² is a straight-chained, branched or cyclic C₂-C₆ alkyl group or an aryl group, and n≧1; (b) HO(CHR¹CH₂O)ₙR², wherein R¹ is hydrogen or a methyl group, R² is a straight-chained, branched or cyclic C₂-C₆ alkyl group or an aryl group, and n≧1; and (c) C₂ₙH₄ₙ₊₂Oₙ₊₁, wherein n≧1, and (d) H(OCH₂CH₂)ₙOH, wherein n≧1.

13. The composition of claim 11, wherein co-solvent B comprises a polyglycol ether selected from the group consisting of diethylene glycol monomethyl ether, triethylene glycol monomethyl ether, diethylene glycol monoethyl ether, triethylene glycol monoethyl ether, ethylene glycol monopropyl ether, ethylene glycol monobutyl ether, diethylene glycol monobutyl ether, triethylene glycol monobutyl ether, ethylene glycol monohexyl ether, diethylene glycol monohexyl ether, ethylene glycol phenyl ether, propylene glycol methyl ether, dipropylene glycol methyl ether, tripropylene glycol methyl ether, propylene glycol n-propyl ether, dipropylene glycol n-propyl ether, tripropylene glycol n-propyl ether, propylene glycol n-butyl ether, dipropylene glycol n-butyl ether, tripropylene glycol n-butyl ether, and propylene glycol phenyl ether.

14. The composition of claim 11, wherein co-solvent B comprises diethylene glycol monobutyl ether.

15. The composition of claim 2, comprising chelator.

16. The composition of claim 15, wherein the chelator comprises a chelator species selected from the group consisting of: triazoles; triazoles substituted with substituent(s) selected from the group consisting of C₁-C₈ alkyl, amino, thiol, mercapto, imino, carboxy and nitro; thiazoles; tetrazoles; imidazoles; phosphates; thiols; azines; glycerols; amino acids; carboxylic acids; alcohols; amides; and quinolines.

17. The composition of claim 15, wherein the chelator comprises a compound selected from the group consisting of benzotriazole, tolyltriazole, 5-phenyl-benzotriazole, 5-nitro-benzotriazole, 3-amino-5-mercapto-1,2,4-triazole, 1-amino-1,2,4-triazole, hydroxybenzotriazole, 2-(5-amino-pentyl)-benzotriazole, 1-amino-1,2,3-triazole, 1-amino-5-methyl- 1,2,3-triazole, 3-amino-1,2,4-triazole, 3-mercapto-1,2,4-triazole, 3-isopropyl-1,2,4-triazole, 5-phenylthiol-benzotriazole, halo-benzotriazoles, naphthotriazole, 2-mercaptobenzoimidizole, 2-mercaptobenzothiazole, 4-methyl-2-phenylimidazole, 2-mercaptothiazoline, 5-aminotetrazole, 5-amino-1,3,4-thiadiazole-2-thiol, 2,4-diamino-6-methyl-1,3,5-triazine, thiazole, triazine, methyltetrazole, 1,3-dimethyl-2-imidazolidinone, 1,5-pentamethylenetetrazole, 1-phenyl-5-mercaptotetrazole, diaminomethyltriazine, mercaptobenzothiazole, imidazoline thione, mercaptobenzimidazole, 4-methyl-4H-1,2,4-triazole-3-thiol, 5-amino-1,3,4-thiadiazole-2-thiol, benzothiazole, tritolyl phosphate, and indiazole.

18. The composition of claim 15, wherein the chelator is 2-mercaptobenzimidazole.

19. The composition of claim 2, wherein a polar component of the surface tension (γₚ) of the composition is about 10.0 dyne/cm² to about 0 dyne/cm².

20. The composition of claim 2, wherein the surface tension (γ) of the composition is about 25 dyne/cm² to about 45 dyne/cm².

21. The composition of claim 2, selected from the group consisting of Formulations A-C, wherein all percentages are by weight, based on the total weight of the formulation:
Formulation A
5.0% tetramethylammonium hydroxide;
25.0% diethylene glycol monomethyl ether;
4.0% diethylene glycol monobutyl ether; and
66.0% water;
Formulation B
5.0% tetramethylammonium hydroxide;
20.0% diethylene glycol monomethyl ether;
8.0% diethylene glycol monobutyl ether; and
67.0% water; and
Formulation C
5.0% tetramethylammonium hydroxide;
20.0% diethylene glycol monomethyl ether;
10.0% diethylene glycol monobutyl ether; and
65.0% water.

22. The composition of claim 11, comprising the following components, based on total weight of the composition:
60.0% wt.-70.0% wt. water
3.0% wt.-7.0% wt. quaternary ammonium hydroxide;
18.0% wt.-25.0% wt. co-solvent A; and
2.0% wt.-12.0% wt. co-solvent B,
wherein the total of the weight percentages of such components of the composition does not exceed 100% weight.

23. A method of removing photoresist and/or BARC material from a substrate having said material thereon, said method comprising contacting the substrate with an aqueous-based removal composition for sufficient time to at least partially remove said material from the substrate, wherein the aqueous-based removal composition includes a quaternary ammonium hydroxide, at least one co-solvent and optionally, a chelator.

24. The method of claim 23, wherein the aqueous-based removal composition comprises the following components, based on the total weight of the composition:
50.0% wt.-90.0% wt. water
1.0% wt.-10.0% wt. quaternary ammonium hydroxide;
1.0% wt.-25.0% wt. co-solvent A;
optionally 0.0% wt.-20.0% wt. co-solvent B; and
optionally 0.0% wt.-1.0% wt. chelator,
wherein the total of the weight percentages of such components of the composition does not exceed 100% weight.

25. The method of claim 23, wherein the substrate comprises a semiconductor device structure.

26. The method of claim 23, wherein the material comprises photoresist.

27. The method of claim 26, wherein the photoresist has been hardened by ion implantation or plasma-etching.

28. The method of claim 23, wherein the material comprises BARC material.

29. The method of claim 28, wherein the BARC material has been applied to a semiconductor device structure to minimize reflectivity variations during photolithographic patterning on the semiconductor device structure.

30. The method of claim 23, wherein said contacting is carried out for a time of from about 1 minute to about 10 minutes.

31. The method of claim 23, wherein said contacting is carried out at temperature in a range of from about 50° C. to about 80° C.

32. The method of claim 24, wherein the quaternary ammonium hydroxide comprises a compound represented by the formula R¹R²R³R⁴N⁺OH⁻, where R¹, R², R³ and R⁴ are the same as or different from one another and are C₁-C₆ alkyl groups or aryl groups.

33. The method of claim 24, wherein the quaternary ammonium hydroxide comprises tetramethylammonium hydroxide (TMAH).

34. The method of claim 24, wherein co-solvent A comprises a compound represented by the formula HO(CH₂CHR¹O)ₙR² or HO(CHR¹CH₂O)ₙR², wherein R¹ is hydrogen or a methyl group, R² is a straight-chained, branched or cyclic C₂-C₆ alkyl group or an aryl group, and n≧1.

35. The method of claim 24, wherein co-solvent A comprises a polyglycol ether selected from the group consisting of diethylene glycol monomethyl ether, triethylene glycol monomethyl ether, diethylene glycol monoethyl ether, triethylene glycol monoethyl ether, ethylene glycol monopropyl ether, ethylene glycol monobutyl ether, diethylene glycol monobutyl ether, triethylene glycol monobutyl ether, ethylene glycol monohexyl ether, diethylene glycol monohexyl ether, ethylene glycol phenyl ether, propylene glycol methyl ether, dipropylene glycol methyl ether, tripropylene glycol methyl ether, propylene glycol n-propyl ether, dipropylene glycol n-propyl ether, tripropylene glycol n-propyl ether, propylene glycol n-butyl ether, dipropylene glycol n-butyl ether, tripropylene glycol n-butyl ether, and propylene glycol phenyl ether.

36. The method of claim 24, wherein co-solvent A comprises diethylene glycol monomethyl ether.

37. The method of claim 24, comprising co-solvent B.

38. The method of claim 37, wherein co-solvent B comprises a compound represented by the formula selected from the group consisting of (a) HO(CH₂CHR¹O)ₙR², wherein R¹ is hydrogen or a methyl group, R² is a straight-chained, branched or cyclic C₂-C₆ alkyl group or an aryl group, and n≧1, (b) HO(CHR¹CH₂O)ₙR², wherein R¹ is hydrogen or a methyl group, R² is a straight-chained, branched or cyclic C₂-C₆ alkyl group or an aryl group, and n≧1, (c) C₂ₙH₄ₙ₊₂Oₙ₊₁, wherein n≧1, and (d) H(OCH₂CH₂)ₙOH, wherein n≧1.

39. The method of claim 37, wherein co-solvent B comprises a polyglycol ether selected from the group consisting of diethylene glycol monomethyl ether, triethylene glycol monomethyl ether, diethylene glycol monoethyl ether, triethylene glycol monoethyl ether, ethylene glycol monopropyl ether, ethylene glycol monobutyl ether, diethylene glycol monobutyl ether, triethylene glycol monobutyl ether, ethylene glycol monohexyl ether, diethylene glycol monohexyl ether, ethylene glycol phenyl ether, propylene glycol methyl ether, dipropylene glycol methyl ether, tripropylene glycol methyl ether, propylene glycol n-propyl ether, dipropylene glycol n-propyl ether, tripropylene glycol n-propyl ether, propylene glycol n-butyl ether, dipropylene glycol n-butyl ether, tripropylene glycol n-butyl ether, and propylene glycol phenyl ether.

40. The method of claim 37, wherein co-solvent B comprises diethylene glycol monobutyl ether.

41. The method of claim 24, comprising chelator.

42. The method of claim 41, wherein the chelator comprises a chelator species selected from the group consisting of: triazoles; triazoles substituted with substituent(s) selected from the group consisting of C₁-C₈ alkyl, amino, thiol, mercapto, imino, carboxy and nitro; thiazoles; tetrazoles; imidazoles; phosphates; thiols; azines; glycerols; amino acids; carboxylic acids; alcohols; amides; and quinolines.

43. The method of claim 41, wherein the chelator comprises a compound selected from the group consisting of benzotriazole, tolyltriazole, 5-phenyl-benzotriazole, 5-nitro-benzotriazole, 3-amino-5-mercapto-1,2,4-triazole, 1-amino-1,2,4-triazole, hydroxybenzotriazole, 2-(5-amino-pentyl)-benzotriazole, 1-amino-1,2,3-triazole, 1-amino-5-methyl-1,2,3-triazole, 3-amino-1,2,4-triazole, 3-mercapto-1,2,4-triazole, 3-isopropyl-1,2,4-triazole, 5-phenylthiol-benzotriazole, halo-benzotriazoles, naphthotriazole, 2-mercaptobenzoimidizole, 2-mercaptobenzothiazole, 4-methyl-2-phenylimidazole, 2-mercaptothiazoline, 5-aminotetrazole, 5-amino-1,3,4-thiadiazole-2-thiol, 2,4-diamino-6-methyl-1,3,5-triazine, thiazole, triazine, methyltetrazole, 1,3-dimethyl-2-imidazolidinone, 1,5-pentamethylenetetrazole, 1-phenyl-5-mercaptotetrazole, diaminomethyltriazine, mercaptobenzothiazole, imidazoline thione, mercaptobenzimidazole, 4-methyl-4H-1,2,4-triazole-3-thiol, 5-amino-1,3,4-thiadiazole-2-thiol, benzothiazole, tritolyl phosphate, and indiazole.

44. The method of claim 41, wherein the chelator is 2-mercaptobenzimidazole.

45. The method of claim 24, wherein the aqueous-based removal composition is selected from the group consisting of Formulations A-C, wherein all percentages are by weight, based on the total weight of the formulation:
Formulation A
5.0% tetramethylammonium hydroxide;
25.0% diethylene glycol monomethyl ether;
4.0% diethylene glycol monobutyl ether; and
66.0% water;
Formulation B
5.0% tetramethylammonium hydroxide;
20.0% diethylene glycol monomethyl ether;
8.0% diethylene glycol monobutyl ether; and
67.0% water; and
Formulation C
5.0% tetramethylammonium hydroxide;
20.0% diethylene glycol monomethyl ether;
10.0% diethylene glycol monobutyl ether; and
65.0% water.

46. The method of claim 37, comprising the following components, based on the total weight of the composition:
60.0% wt.-70.0% wt. water
3.0% wt.-7.0% wt. quaternary ammonium hydroxide;
18.0% wt.-25.0% wt. co-solvent A; and
2.0% wt.-12.0% wt. co-solvent B,
wherein the total of the weight percentages of such components of the composition does not exceed 100% weight.

47. The method of claim 23, further comprising rinsing the substrate with deionized water following contact with the aqueous-based removal composition.

48. The method of claim 23, further comprising inspecting the substrate by optical microscopy to estimate the removal efficiency of the aqueous-based removal composition.

49. The method of claim 48, wherein at least about 80% of the material is removed using the aqueous-based removal composition.

50. The method of claim 24, wherein the surface tension (γ) of the composition is about 25 dyne/cm² to about 45 dyne/cm².

51. An aqueous-based removal composition useful for removing chemical mechanical polishing residue from a substrate having such material(s) thereon, said composition comprising a quaternary ammonium hydroxide, at least one co-solvent and a chelator.

52. A method of removing chemical mechanical polishing residue from a substrate having said material thereon, said method comprising contacting the substrate with an aqueous-based removal composition for sufficient time to at least partially remove said material from the substrate, wherein the aqueous-based removal composition includes a quaternary ammonium hydroxide, at least one co-solvent and a chelator.
